(19) United States
(12) Patent Application Publication
(10) Pub. No.: US 2026/0334515 A1
(43) Pub. Date: Oct. 29, 2026

(54) AN ACIDIC PHYCOCYANIN- AND HYDROCOLLOID-CONTAINING COMPOSITION AND PREPARATION THEREOF

(71) Applicant: FUL FOODS B.V., AMSTERDAM (NL)

(72) Inventors: Julia STREULI, AMSTERDAM (NL); Cristina PRAT, AMSTERDAM (NL); Sara GUAGLIO, AMSTERDAM (NL)

(21) Appl. No.: 19/485,237

(22) PCT Filed: May 17, 2024
(86) PCT No.: PCT/NL2024/050256

§ 371 Date: Nov. 17, 2025

(30) Foreign Application Priority Data
May 19, 2023 (NL) 2034869

(51) Int. Cl. A23L 5/46; A23L 29/231; A23L 29/256; A23L 33/105

(52) U.S. Cl. CPC A23L 5/46; A23L 29/231; A23L 29/256; A23L 33/105

(57) ABSTRACT

A method of producing an aqueous phycocyanin- and hydrocolloid-containing composition includes mixing an aqueous phycocyanin-containing composition with one or more aqueous hydrocolloid-containing compositions, at a pH of between 4.0 and 4.9, preferably between 4.5 and 4.9, wherein the aqueous phycocyanin-containing composition has a phycocyanin concentration of between 0.05 and 50 wt. %, based on the weight of the aqueous phycocyanin-containing composition, wherein the one or more aqueous hydrocolloid-containing compositions comprise multi-sulphated carrageenan and another hydrocolloid, to obtain a mixture having a weight ratio of multi-sulphated carrageenan to phycocyanin of between 0.05:1 and 0.9:1 and having a weight ratio of multi-sulphated carrageenan to the other hydrocolloid of between 1:0.1 to 1:30 to obtain the aqueous phycocyanin- and hydrocolloid-containing composition. An aqueous phycocyanin- and carrageenan-containing composition, to a dried phycocyanin- and carrageenan-containing composition is provided in a method of preparing a food composition and to a food composition.

### FIELD OF THE INVENTION

The present invention relates to a method of producing an aqueous phycocyanin- and hydrocolloid-containing composition, a stabilized aqueous phycocyanin-containing composition, a stabilized dried phycocyanin-containing composition, a method of preparing a food composition by mixing the stabilized phycocyanin-containing composition with one or more diluents, and a food composition comprising the stabilized phycocyanin-containing composition. More in particular, the present invention relates to acid-resistant, thermal-resistant and processable compositions.

### BACKGROUND

The background description includes information that may be useful in understanding the present invention. It is not an admission that any of the information provided herein is prior art or relevant to the presently claimed invention, or that any publication specifically or implicitly referenced is prior art.

Phycocyanin is a pigment-protein complex from the light-harvesting phycobiliprotein family. Phycobiliproteins, accessory pigments to chlorophyll, are fluorescent proteins of various colours, including fuchsia, purple-blue, and cyan, that allow the capture of light energy. phycocyanin has a characteristic light blue colour, absorbing orange and red light, particularly near 620 nm, and emits fluorescence at about 650 nm. Phycocyanin is used in food and beverages. It is approved as food additive in both the US and the EU. In the US it is exempt from certification. In the EU it doesn't require an E-number (usually required for food additive certification). Phycocyanin is further used in cosmetics and drugs as a natural colouring agent, as well as in fluorescent reagents, -probes and -tracers used in medical diagnosis, immunology, biological engineering and in research. Phycocyanin has nutritional benefits due to its antioxidant, anti-inflammatory, and anti-cancer properties. Phycocyanin may be extracted from sources such cyanobacteria and algae.

Phycocyanin, however, has the disadvantage of being unstable in aqueous acidic solutions and upon thermal treatment. Adding phycocyanin to an aqueous acidic solution leads to aggregation and subsequent precipitation and/or sediment formation, as well as to the loss of colour intensity and/or change in colour hue of the phycocyanin. Further, thermal treatment and/or the addition of preservatives may affect stability, in particular the stability of the colour intensity and/or colour hue. Another issue is the fact that phycocyanin exhibits low colour stability at low pH (e.g., at a pH below 5, and even more so at pH levels below 4 or even below 3.5) and/or at high temperatures (e.g., at temperatures above 40 °C, and even more so at temperatures above 70 °C or above 90 °C or even above 95 °C; making phycocyanin-containing compositions very difficult to be integrated in final consumer applications, which often require low pH in the final composition (e.g. in yoghurt or beverage applications) and high temperature during processing (e.g. during pasteurization).

In light of this, new methods to stabilize phycocyanin would be highly desirable. Further, there is a clear need in the art for stabilized phycocyanin-containing products, such as food products and methods for producing such products.

From the Philippine Journal of Science (volume 147, issue 2, pages 201-207, June 2018) in the name of Dewi et al is known the publication entitled: “Physical Properties of Spirulina Phycocyanin Microencapsulated with Maltodextrin and Carrageenan”. This publication studies the use of microencapsulation of phycocyanin using maltodextrin and carrageenan. The disadvantage of that method is that a high content of maltodextrin is required which is undesirable.

Accordingly, the technical problem underlying the present invention can be seen in the provision of such methods, and products for complying with any of the aforementioned needs. The technical problem is solved by the embodiments characterized in the claims and herein below.

It is an object of the present invention to provide an improved method for producing an acidic aqueous phycocyanin- and hydrocolloid-containing composition. It is a further object of the present invention to provide a stabilized acidic aqueous phycocyanin-containing composition. It is a further a specific object of the present invention to provide a stabilized dried aqueous phycocyanin-containing composition. It is a further object of the invention to provide an acid-resistant, thermal-resistant, and processable composition. It is a furthermore a specific object of the present invention to provide a method of preparing a food composition comprising a stabilized phycocyanin-containing composition, as well as a food composition comprising a stabilized phycocyanin-containing composition.

### Statement of the Invention

In one aspect, the invention relates to a method of producing an aqueous phycocyanin- and hydrocolloid-containing composition, the method comprising mixing an aqueous phycocyanin-containing composition with one or more aqueous hydrocolloid-containing compositions, at a pH of between 4.0 and 4.9, preferably between 4.5 and 4.9,
wherein the aqueous phycocyanin-containing composition has a phycocyanin concentration of between 0.05 and 50 wt. %, based on the weight of the aqueous phycocyanin-containing composition,
wherein the one or more aqueous hydrocolloid-containing compositions comprise multi-sulphated carrageenan and another hydrocolloid, preferably a pectin or a gum, more preferably selected from the group consisting of citrus pectin, beet pectin, arabic gum, acacia gum, cellulose gum, gellan gum, guar gum, locust bean gum, and xanthan gum, and one or more combinations thereof,
to obtain a mixture having a weight ratio of multi-sulphated carrageenan to phycocyanin of between 0.05:1 and 0.9:1 and having a weight ratio of multi-sulphated carrageenan to the other hydrocolloid of between 1:0.1 to 1:30 to obtain the aqueous phycocyanin- and hydrocolloid-containing composition.

In a second aspect, the invention relates to an aqueous phycocyanin- and carrageenan-containing composition, comprising:
between 40 and 99 wt. % of water, preferably between 65 and 98 wt. %,
between 0.05 and 55 wt. % of phycocyanin,
multi-sulphated carrageenan in a weight ratio of multi-sulphated carrageenan to phycocyanin of between 0.05:1 and 0.9:1,
another hydrocolloid in a weight ratio of multi-sulphated carrageenan to the other hydrocolloid of between 1:0.1 to 1:30,
optionally chitosan in a weight ratio of phycocyanin to chitosan of between 1:1 and 7:1, preferably between 1.5:1 and 5:1,
said composition having a pH of between 2.5 and 3.9, preferably between 2.8 and 3.6.

In a third aspect, the invention relates to a dried phycocyanin- and carrageenan-containing composition, comprising:
between 1 and 15 wt. % of water.
between 2 and 90 wt. % of phycocyanin,
multi-sulphated carrageenan in a weight ratio of multi-sulphated carrageenan to phycocyanin of between 0.05:1 and 0.9:1,
another hydrocolloid in a weight ratio of multi-sulphated carrageenan to the other hydrocolloid of between 1:0.1 to 1:30,
optionally chitosan in a weight ratio of phycocyanin to chitosan of between 1:1 and 7:1, preferably between 1.5:1 and 5:1, and
said composition having a pH of between 2.5 and 3.9, preferably between 2.8 and 3.6.

In a fourth aspect the present invention relates to a method of preparing a food composition by mixing the phycocyanin- and hydrocolloid-containing composition according the invention or obtained according to the method of the invention with one or more diluents selected from the group consisting of water, milk, plant-based milk, and juices and/or one or more further ingredients selected from the group consisting of flavouring agents, fibers, inulins, chelating agents, spices, emulsifiers, hydrocolloids, herb extracts, vitamins, and minerals, to a concentration of phycocyanin of between 0.001 and 20 wt. %, optionally diluting with water, optionally adjusting the pH, to achieve a composition having a pH of between 2.5 and 3.9.

In a fifth aspect the present invention relates to a food composition comprising the phycocyanin- and hydrocolloid-containing composition of the invention or obtained according to the method of the invention having a concentration of phycocyanin of between 0.001 and 20 wt. % (for example 0.01 wt. % and 20 wt. %), having a pH of between 2.5 and 7, and optionally further comprising milk, plant-based milk, juices, flavours, chelating agents, spices, emulsifiers, hydrocolloids, herb extracts, vitamins, and minerals.

Below several preferred features are disclosed. These features are applicable to the methods as well as to the compositions unless specified otherwise.

### DETAILED DESCRIPTION

The present invention is elucidated below with a detailed description. When used in these specification and claims, the terms “comprises” and “comprising” and variations thereof mean that the specified features, steps or integers are included. The terms are not to be interpreted to exclude the presence of other features, steps, or components.

The present method of producing an aqueous phycocyanin- and carrageenan-containing composition, comprises several steps of which some are optional. All of the steps (denoted with a) to i)) are discussed separately below.

The present invention provides a method to stabilize phycocyanin containing compositions at low PH levels, such as at pH values of between 4.0 and 4.9, preferably between 4.5 and 4.9 and using low weight ratios of the hydrocolloid multi-sulphated carrageenan to phycocyanin, such as a weight ratio of less than 1. The present inventors have observed that this leads to improved phase and colour stability at low pH of between 2.5 and 3.9, improved phase and colour stability upon drying of the compositions, a shelf stable aqueous phycocyanin containing composition that is easy to process, e.g. easy to carbonate, easy to can or bottle in a commercial setting in a beverage format, and/or easy to dry due to the lower viscosity and foam formation.

### DEFINITIONS

Various terms relating to the methods, compositions, uses and other aspects of the present invention are used throughout the specification and claims. Such terms are to be given their ordinary meaning in the art to which the invention pertains, unless otherwise indicated.

Other specifically defined terms are to be construed in a manner consistent with the definition provided herein. Although any methods and materials similar or equivalent to those described herein can be used in the practice for testing of the present invention, the preferred materials and methods are described herein.

For purposes of the present invention, the following terms are defined below.

As used herein, the singular form terms “a,” “an,” and “the” include plural referents unless the content clearly dictates otherwise. Thus, for example, reference to “a bacterium” includes a combination of two or more individual bacteria, and the like.

As used herein, “and/or” refers to a situation wherein one or more of the stated cases may occur, alone or in combination with at least one of the stated cases, up to with all of the stated cases.

As used herein, “at least” a particular value means that particular value or more. For example, “at least 2” is understood to be the same as “2 or more” i.e., 2, 3, 4, 5, 6, 7, 8, 9, 10, 11, 12, 13, 14, 15, etc. As used herein, the term “at most” a particular value means that particular value or less. For example, “at most 5” is understood to be the same as “5 or less” i.e., 5, 4, 3, −10, −11, etc.

As used herein, “comprising” or “to comprise” is construed as being inclusive and open ended, and not exclusive. Specifically, the terms and variations of the specified features, steps or components are included. These terms are not to be interpreted to exclude the presence of other features, steps or components. It also encompasses the more limiting “to consist of”.

As used herein, “as is known to the skilled person” refers to a situation wherein the methods of carrying out the conventional techniques used in methods of the invention will be evident to the skilled worker. The practice of conventional techniques in molecular biology, biochemistry, cell culture, genomics, sequencing, medical treatment, pharmacology, immunology, and related fields are well-known to those of skill in the art and are discussed, in various handbooks and literature references.

As used herein, “hydrocolloid” refers to a high molecular weight hydrophilic polymer containing polar or charged functional groups, rendering them soluble in water.

As used herein, “another hydrocolloid” or “the other hydrocolloid” refers to hydrocolloids not being multi-sulphated carrageenan. Examples may be citrus pectin, beet pectin, arabic gum, acacia gum, cellulose gum, gellan gum, guar gum, locust bean gum, and xanthan gum.

As used herein, “aqueous hydrocolloid-containing composition” refers to a solution or a gel in which the solvent is water and additionally comprises one or more types of hydrocolloids.

As used herein, “aqueous phycocyanin-containing composition” refers to a solution in which the solvent is water and additionally comprises phycocyanin.

As used herein, “carrageenan” refers to high-molecular-weight polysaccharides having disaccharide repeating units, which are mainly comprised of 3-linked beta-D-galactopyranose units and either 4-linked alpha-D-galactopyranose units or 4-linked 3,6-anhydro-alpha-D-galactopyranose units.

As used herein, “multi-sulphated carrageenan” refers carrageenan having more than one sulphate group per disaccharide moiety. Kappa-carrageenan has one sulphate group per disaccharide (not a multi-sulphated carrageenan), iota-carrageenan has two, and lambda-carrageenan has three, both of which are considered multi-sulphated carrageenan, the latter being preferred.

As used herein, “chitosan” refers to a linear polysaccharide composed of randomly distributed β-(1-4)-linked D-glucosamine and N-acetyl-D-glucosamine units. It is obtained from the chitin shells of shrimp and other crustaceans and treatment thereof with an alkaline substance.

As used herein, “pectin” refers to a heteropolysaccharide based on galacturonic acid. Pectin is contained in the primary lamella, in the middle lamella, and in the cell walls of plants and it is normally produced from citrus fruits.

As used herein, “phycobiliprotein” refers to a light-harvesting, fluorescent protein complex, accessory to chlorophyll, of various colours, including fuchsia, purple-blue and cyan, that allow the capture of light energy.

As used herein, “phycocyanin” refers to a type of phycobiliprotein. Phycocyanin has a characteristic light blue colour, absorbing orange and red light, particularly near 620 nm, and emits fluorescence at about 650 nm. Phycocyanin is a pigment-protein complex from the light-harvesting phycobiliprotein family.

The compositions according to the present invention are preferably food grade compositions, such as edible or drinkable compositions.

### BRIEF DESCRIPTIONS OF THE DRAWINGS

The present invention is described hereinafter with reference to the accompanying drawings in which embodiments of the present invention are shown and in which like reference numbers indicate the same or similar elements.

FIG. 1 is shows pictures of visual determination of phase stability of compositions according to the invention and not according to the invention.

### DETAILED DESCRIPTION OF EMBODIMENTS

The present invention relates to a method of producing an aqueous phycocyanin- and hydrocolloid-containing composition, the method comprises mixing an aqueous phycocyanin-containing composition with one or more aqueous hydrocolloid-containing compositions, at a pH of between 4.0 and 4.9. More details are provided below.

### Aqueous Phycocyanin-Containing Composition.

The method involves the use of an aqueous phycocyanin-containing composition.

The aqueous phycocyanin-containing composition has a phycocyanin concentration of between 0.05 and 50 wt. %, based on the weight of the aqueous phycocyanin-containing composition. The aqueous phycocyanin-containing composition preferably has a phycocyanin concentration of between 0.1 wt. % and 20 wt. %, more preferably between 0.15 wt. % and 10 wt. %, most preferably between 0.2 wt. % and 5 wt. %.

The aqueous phycocyanin-containing composition optionally comprises chitosan in a weight ratio of phycocyanin to chitosan of between 1:1 and 7:1, preferably between 1.5:1 and 5:1.

Preferably, the pH of the aqueous phycocyanin-containing composition is between 4.0 and 4.9, more preferably between 4.5 and 4.9. According to the method of the present invention, the pH of the aqueous phycocyanin-containing composition (optionally comprising another hydrocolloid) is between 4.0 and 4.9 (most preferably between 4.5 and 4.9) prior to the addition of the multi-sulphated carrageenan. This will have the effect of providing a strong stabilizing bond between the phycocyanin and the carrageenan to allow for the stabilisation according to the invention. The pH may be adjusted using a mild base or salt.

The aqueous phycocyanin-containing composition has a total protein concentration of between 0.05 and 80 wt. %, preferably between 0.15 and 65 wt. %, more preferably between 0.2 and 30 wt. %, preferably between 0.5 and 10 wt. %, more preferably between 0.8 and 8 wt. %, based on the weight of the starting composition. The total protein concentration comprises phycocyanin and other soluble proteins, such as allophycocyanin and phycoerythrin or non-phycobiliproteins, peptides or amino acids. This total protein range has the effect of having optimal nutritional value.

In an embodiment, the aqueous phycocyanin-containing composition is a phycocyanin extract. The aqueous phycocyanin-containing composition may be an extract, for example that is obtained according to the method disclosed in International Patent application PCT/NL2022/050654 (filed 15-11-2022) in the name of the present applicant. If needed, the pH of the extract may be adjusted to be in the required range.

In specific embodiments, the provision of the aqueous phycocyanin-containing composition is denoted by step a) of providing an aqueous phycocyanin-containing composition having a phycocyanin concentration of between 0.05 and 50 wt. %, based on the weight of the aqueous phycocyanin-containing composition, optionally further comprising chitosan in a weight ratio of phycocyanin to chitosan of between 1:1 and 7:1, preferably between 1.5:1 and 5:1.

In an embodiment, the aqueous phycocyanin-containing composition is a diluted phycocyanin extract. If needed, the extract (e.g., as obtained according to the method disclosed in International Patent application PCT/NL2022/050654) may be diluted with water prior to use and the pH may be adjusted prior to and/or after dilution, preferably after dilution.

The starting composition optionally further comprises chitosan in a weight ratio of phycocyanin to chitosan of between 1:1 and 7:1, preferably between 1.5:1 and 5:1. The presence of chitosan has the effect of increasing the stabilisation of the phycocyanin- and hydrocolloid-containing composition. Without being wishing to be bound by any particular theory, the present inventors have observed that chitosan is positively charged below pH 5, which leads to a weak electrostatic interaction with phycocyanin which is negatively charged above its isoelectric point, helping to stabilise the phycocyanin containing solution at the pH of the treatment before the other hydrocolloids are added. This weight ratio range is the optimum range to avoid flocculation of proteins or aggregates and undesired interactions with the other hydrocolloids.

In an embodiment, step a) comprises the following sub-steps a1), a2), and a3), which will each be discussed below.

### Step a1) Diluting Extract.

Step a1) comprises diluting a phycocyanin extract to obtain an aqueous phycocyanin-containing composition having a phycocyanin concentration of between 0.05 and 50 wt. %, based on the weight of the us phycocyanin-containing composition.

### Step a2) Adding Chitosan.

Step a2) is an optional step and is related to adding to the diluted extract of step a1) an aqueous homogenized chitosan solution to obtain a mixture having a weight ratio of phycocyanin to chitosan of between 1:1 and 7:1, preferably between 1.5:1 and 5:1. The effect of chitosan will be discussed below.

### Step a3) Adding an Acid or a Salt.

Step a3) is an optional step and is related to adding an organic acid or salt, such as citric acid or sodium citrate to the mixture obtained in step a1) or a2) to obtain an aqueous phycocyanin-containing starting composition having a pH of between 4.0 and 4.9 such as between 4.5 to 4.9.

As discussed above, the present invention requires a specific pH range of the aqueous phycocyanin-containing starting composition. This specific pH range may be obtained if the used aqueous phycocyanin-containing starting composition has a pH that is 5.0 or higher by adding an organic acid. As an example, citric acid may be mentioned. Other possible organic acids that may be used are lactic acid, malic acid, lemon juice or lime juice. If the used aqueous phycocyanin-containing starting composition has a pH that lower than 4, the desired pH can be adjusted by adding a salt. As an example, sodium citrate is added.

### Aqueous Hydrocolloid-Containing Compositions

The method involves the use of an aqueous hydrocolloid-containing composition or two or more aqueous hydrocolloid-containing composition.

In the one or more aqueous hydrocolloid-containing composition at least two hydrocolloids are present, being i) multi-sulphated carrageenan, and ii) another hydrocolloid. The other hydrocolloid is preferably a pectin or a gum or a combination thereof, more preferably selected from the group consisting of citrus pectin, beet pectin, arabic gum, acacia gum, cellulose gum, gellan gum, guar gum, locust bean gum, and xanthan gum and one or more combination thereof.

In an embodiment, a first aqueous hydrocolloid-containing composition comprises as a hydrocolloid multi-sulphated carrageenan, preferably having a pH of between 3.0 and 7.0. In this embodiment, a second aqueous hydrocolloid-containing composition is used comprising one or more other hydrocolloids, preferably having a pH of between 2.0 and 5.0, preferably a pectin or a gum, more preferably selected from the group consisting of citrus pectin, beet pectin, arabic gum, acacia gum, cellulose gum, gellan gum, guar gum, locust bean gum, and xanthan gum and one or more combination thereof.

In an embodiment, the first aqueous hydrocolloid-containing composition comprises only one type of hydrocolloid, being multi-sulphated carrageenan, said composition preferably having a pH of between 3.0 and 7.0 and the second aqueous hydrocolloid-containing composition comprising only one type of hydrocolloids, selected from the group consisting of citrus pectin, beet pectin, arabic gum, acacia gum, cellulose gum, gellan gum, guar gum, locust bean gum, and xanthan gum, said composition preferably having a pH of between 2.0 and 5.0.

In a specific embodiment, the first aqueous hydrocolloid-containing composition comprises multi-sulphated carrageenan and has a pH of between 3.0 and 7.0 and the second aqueous hydrocolloid-containing composition comprising a pectin or a gum and has a pH of between 2.0 and 5.0.

In an embodiment, multi-sulphated carrageenan and the other hydrocolloid are present in one single aqueous hydrocolloid-containing composition. In other words, there are two hydrocolloids present in one hydrocolloid-containing composition. Preferably, the one aqueous hydrocolloid-containing composition having a pH of between 4.0 and 4.9 or more preferably between 4.5 and 4.9. This ensures that the mixing with the aqueous phycocyanin-containing composition (see below) can be carried out in this pH range. In a specific embodiment, the aqueous hydrocolloid-containing composition comprises multi-sulphated carrageenan and xanthan gum and has a pH of between 4 and 4.9 or 4.0 and 4.9.

In an embodiment, step b) is a step of providing an aqueous hydrocolloid-composition comprising multi-sulphated carrageenan. In an embodiment, step b) is a step of providing an aqueous hydrocolloid-composition comprising multi-sulphated carrageenan and another hydrocolloid; in this embodiment steps b) and c) are combined into one single step b).

Preferably, as carrageenan lambda (λ) carrageenan is used. Preferably, said composition has a carrageenan concentration of between 1 and 6 wt. %, preferably between 3 and 5 wt. %, preferably approximately 4 wt. %. The present inventors have observed that a carrageen solution in this concentration ranges provides an optimal balance between solubility of the carrageenan in the carrageenan solution as well as optimal concentration of the carrageenan and phycocyanin after mixing of the two solutions (see below steps).

Preferably, as the other hydrocolloid pectin is used. Preferably, said composition has a concentration of the other hydrocolloid of between 1 and 25 wt. %, preferably between 4 and 15 wt. %. The present inventors have observed that a concentration in these ranges provides an optimal balance between solubility of the other hydrocolloid in the hydrocolloid solution as well as optimal concentration of the other hydrocolloid and phycocyanin after mixing of the two solutions (see below steps).

In an embodiment, step b) comprises the sub-steps b1)-b3), which are described below.

### Step b1) Dissolving Carrageenan in Water.

Step b1) relates to preparing a solution of carrageenan in water, preferably demi-water, to obtain a solution having a carrageenan concentration of between 1 and 6 wt. %, preferably between 3 and 5 wt. %, preferably approximately 4 wt. %. The carrageenan solution may be prepared by dissolving carrageenan powder in water (preferably demi-water), for example at a temperature of between 4 and 80 °C.

### Step b2) Homogenizing Carrageenan in Water.

Step b2) relates to homogenizing the solution of step b1) for a period of at least 15 seconds, preferably for at least 30 seconds, by high-pressure mixing, high shear mixing or homogenization, such as for example by using an ULTRA-TURRAX® homogenizer.

The carrageenan solution may be homogenized using a stirring speed of between 2-12 rpm (×1000) rpm for a duration of between 5 and 120 seconds, preferably between 15 and 45 seconds, to obtain a homogeneous solution.

This step may be carried out at temperature of between, 20 and 80 °C, and heat may be applied, if required to obtain a homogeneous solution.

### Step b3) Adding a Food Grade Base.

Step b3) is an optional step comprising adding a food grade base, for example sodium citrate, to adjusting the pH of the aqueous hydrocolloid-composition to a value of between 4.0 and 4.9, preferably between 4.5 and 4.9 if needed.

In an embodiment, step c) is related to providing a second aqueous composition comprising another hydrocolloid (not being multi-sulphated carrageenan), preferably a pectin or gum. The advantages of which are discussed below. In an embodiment, step c) comprises the sub-steps c1)-c3), which are described below.

### Step c1) Dissolving Another Hydrocolloid (e.g., Pectin) in Water.

Step c1) relates to preparing a solution of the other hydrocolloid (e.g., pectin or gum), preferably citrus pectin, or beet pectin or xanthan gum, in water having a concentration of the other hydrocolloid of between 1 and 30 wt. %, preferably between 1 and 15 wt. %.

### Step c2) Homogenizing of the Other Hydrocolloid in Water.

Step c2) relates to homogenizing the solution of step c1) for a period of at least 15 seconds, preferably for at least 30 seconds, by high-pressure mixing, high shear mixing or homogenization, such as for example by using an ULTRA-TURRAX® homogenizer.

The solution may be homogenized using a stirring speed of between 2-12 rpm (×1000) for a duration of between 1 and 20 minutes, preferably between 10 and 15 minutes to obtain a homogeneous solution. This step may be carried out at temperature of between, 20 and 80 °C, and heat may be applied, if required to obtain a homogeneous solution.

### Step c3) Adding a Food Grade Base.

Step c3) is an optional step comprising adding a food grade base, for example sodium citrate, to adjusting the pH of the aqueous hydrocolloid-composition to a value of between 4.0 and 4.9, preferably between 4.5 and 4.9 if needed.

In some specific embodiments, step c) is not present since it is combined with step b).

### Mixing of the Compositions

The method of the invention involves the mixing of the aqueous phycocyanin-containing composition with one or more aqueous hydrocolloid-containing compositions at a pH of between 4.0 and 4.9 or more preferably between 4.5 and 4.9.

The mixture will have a weight ratio of multi-sulphated carrageenan to phycocyanin of between 0.05:1 and 0.9:1 (or between 0.05:1 and 0.35:1 or between >0.35:1 and 0.9:1). For example, at least 0.1, at least 0.2, at least 0.25 or at least 0.3, or above 0.35. for example, at most 0.8, at most 0.7, at most 0.6 at most 0.5, at most 0.4, at most 0.35.

The mixture will have a weight ratio of multi-sulphated carrageenan to the one or more other hydrocolloids of between 1:0.1 and 1:30, such as between 1:0.1 to 1:20, preferably between 1:0.1 and 1:10. The advantage of using one or more other hydrocolloids in addition to multi-sulphated carrageenan is that the amount of multi-sulphated carrageenan can be kept relatively low, avoiding adverse effects of multi-sulphated carrageenan, at a loss of phase stability, but still achieving the required colour stability. The one or more other hydrocolloids are added to increase phase stability to the required level.

In case two separate hydrocolloid-containing compositions are used the order of steps may be that the aqueous hydrocolloid-containing composition comprising carrageenan is first added to the aqueous phycocyanin-containing composition and thereafter the aqueous hydrocolloid-containing composition comprising the other hydrocolloid (e.g., pectin) is added to the mixture obtained. The order of steps may be also that the aqueous hydrocolloid-containing composition comprising the other hydrocolloid (e.g., pectin) is first added to the aqueous phycocyanin-containing composition and thereafter the aqueous hydrocolloid-containing composition comprising carrageenan is added to the mixture obtained. Four specific embodiments are discussed below in more detail.

The preferred weight ratio of a multi-sulphated carrageenan to phycocyanin depends on the water content of the mixture obtained (the aqueous phycocyanin- and hydrocolloid-containing composition).

In an embodiment, for mixture obtained having a water content of less than or equal to 45 wt. % based on the weight of the mixture, the weight ratio of a multi-sulphated carrageenan to phycocyanin is between 0.05:1 and 0.35:1. With less than or equal 45 wt. % is meant any value less than 45 wt. % and including 45 wt. %, such as between 0 and 45 wt. %, or between 1 and 45 wt. % (including both end points).

In an embodiment, for mixture obtained having a water content of above 45 wt. % based on the weight of the mixture, the weight ratio of a multi-sulphated carrageenan to phycocyanin is between 0.05:1 and 0.9:1, such as between >0.35:1 and 0:9:1. With more than 45 wt. % is meant any value over 45 wt. %, not including 45 wt. % (for example between more than 45 and 99 wt. %).

For higher water concentrations (above 45 wt. %) the present inventors have observed—without wishing to be bound by a particular theory, that the interaction between the hydrocolloids and the phycocyanin are strong enough to stabilise (protect) the colour, but not sufficient prevent protein precipitation, hence the phase stability is not considered, and higher ratios of carrageenan are required for some embodiments.

For lower water concentrations (45 wt. % or below) the present inventors have observed-without wishing to be bound by a particular theory, that the phycocyanin it is already phase stable (does not precipitate) and it only requires encapsulation to protect the colour which can be achieved at a lower carrageenan concentration. It is preferred to lower the amount of carrageenan for increased processability.

In a first specific embodiment, discussed below, this step is denoted as step d) mixing the aqueous phycocyanin-containing composition of step a) with the aqueous hydrocolloid-containing composition of step b) at a pH of between 4.0 and 4.9, preferably between 4.5 and 4.9 to obtain a mixture having a weight ratio of multi-sulphated carrageenan to phycocyanin of between 0.05:1 and 0.9:1.

In a second and a fourth specific embodiment, discussed below, this step is denoted as step d) mixing the first aqueous phycocyanin-containing composition of step a) with the aqueous hydrocolloid-containing composition of step b) at a pH of between 4.0 and 4.9, preferably between 4.5 and 4.9 to obtain a mixture having a weight ratio of multi-sulphated carrageenan to phycocyanin of between 0.05:1 and 0.9:1.

In a third specific embodiment, discussed below, this step is denoted as step d) mixing the pH-adjusted mixture of the intermediate step with the aqueous hydrocolloid-containing composition of step b) at a pH of between 4.0 and 4.9, preferably between 4.5 and 4.9 to obtain a mixture having a weight ratio of multi-sulphated carrageenan to phycocyanin of between 0.05:1 and 0.9:1. In this specific embodiment, there is an intermediate step of adjusting (e.g. increasing) the pH of the mixture obtained in step e) to a value of between 4.0 and 4.9, preferably between 4.5 and 4.9 to obtain a pH-adjusted mixture, for example by a food grade base, for example sodium citrate.

In the second and third embodiments, discussed below, there is in addition to step d) a step e) of adding the second aqueous hydrocolloid-containing composition of step c) to the mixture obtained in step d) to obtain a mixture.

In the fourth specific embodiments, there is in addition to step d) a step e) of adding the second aqueous hydrocolloid-containing composition of step c) to the acidic mixture obtained in step f) to obtain an aqueous phycocyanin- and hydrocolloid-containing composition having a weight ratio of multi-sulphated carrageenan to hydrocolloid of between 1:0.1 to 1:30 to obtain a mixture.

The other hydrocolloid sterically stabilizes phycocyanin and other types of proteins present in cow and plant-based milk. An additional advantage in case of adding another hydrocolloid, e.g., a pectin or a gum, solution to a (low pH) food composition comprising cow and/or plant-based milks is that it prevents curdling caused mostly because of precipitation of milk proteins due to reactivity with low pH phycocyanin containing composition.

### Lowering of pH

In an embodiment, the method may further comprise lowering the pH of the aqueous phycocyanin- and hydrocolloid-containing composition to a value of between 2.5 and 3.9, to obtain an acidic aqueous phycocyanin- and hydrocolloid-containing composition. The pH may be adjusted at different stages during the process.

For the first, second and third specific embodiments, discussed below this step is denoted by step f) lowering the pH of the mixture obtained in step e) to a value of between 2.5 and 3.9, to obtain an acidic aqueous phycocyanin- and hydrocolloid-containing composition. This step is carried out after the other compositions have been mixed.

For the fourth specific embodiment, discussed below this step is denoted by step f) lowering the pH of the mixture obtained in step d) to a value of between 2.5 and 3.9. This step is carried out after the phycocyanin- and carrageenan-comprising compositions have been mixed but prior to addition of the other hydrocolloid.

In another embodiment, in case two aqueous hydrocolloid-containing compositions are used the method comprises the steps of mixing an aqueous phycocyanin-containing composition with one aqueous hydrocolloid-containing composition comprising multi-sulphated carrageenan, at a pH of between 4.0 and 4.9 or more preferably between 4.5 and 4.9, then lowering the pH of the mixture to a value of between 2.5 and 3.9, and then adding the other hydrocolloid-containing composition comprising the other hydrocolloid to obtain an acidic aqueous phycocyanin- and hydrocolloid-containing composition.

### SPECIFIC EMBODIMENTS

There are several different possibilities regarding the order of additions. These embodiments, all falling within the scope of claim 1 are discussed here.

### Specific Embodiment 1

In this specific embodiment, step a) comprises the provision of an aqueous phycocyanin-containing composition, step b) comprise the provision of a providing a first and only aqueous hydrocolloid-containing composition comprising multi-sulphated carrageenan as well as another hydrocolloid, step d) comprises mixing these two compositions, and step f) comprises lowering the pH.

This embodiment thus discloses the following method according to the invention: a method comprising the steps of:
a) providing an aqueous phycocyanin-containing composition having a phycocyanin concentration of between 0.05 and 50 wt. %, based on the weight of the aqueous phycocyanin-containing composition, optionally further comprising chitosan in a weight ratio of phycocyanin to chitosan of between 1:1 and 7:1, preferably between 1.5:1 and 5:1,
b) providing an aqueous hydrocolloid-containing composition comprising multi-sulphated carrageenan and another hydrocolloid,
d) mixing the aqueous phycocyanin-containing composition of step a) with the aqueous hydrocolloid-containing composition of step b) at a pH of between 4.0 and 4.9, preferably between 4.5 and 4.9 to obtain a mixture having a weight ratio of multi-sulphated carrageenan to phycocyanin of between 0.05:1 and 0.9:1, and a weight ratio of multi-sulphated carrageenan to the other hydrocolloid of between 1:0.1 to 1:30, and
f) lowering the pH of the mixture obtained in step e) to a value of between 2.5 and 3.9, to obtain an acidic aqueous phycocyanin- and hydrocolloid-containing composition.

### Specific Embodiment 2

In this specific embodiment, the order of steps is a), b), d), c), e) and f). Step a) comprises the provision of an aqueous phycocyanin-containing composition, step b) comprises the provision of a providing a first aqueous hydrocolloid-containing composition comprising multi-sulphated carrageenan, step d) comprises mixing the phycocyanin-containing composition of step a) with the aqueous hydrocolloid-containing composition of step b), step c) comprises the provision of a second aqueous hydrocolloid-containing composition comprising another hydrocolloid, step e) comprises adding the second aqueous hydrocolloid-containing composition of step c) to the mixture obtained in step d) and step f) comprises lowering the pH.

This embodiment thus discloses the following method according to the invention: a method comprising the steps of:
a) providing an aqueous phycocyanin-containing composition having a phycocyanin concentration of between 0.05 and 50 wt. %, based on the weight of the aqueous phycocyanin-containing composition, optionally further comprising chitosan in a weight ratio of phycocyanin to chitosan of between 1:1 and 7:1, preferably between 1.5:1 and 5:1;
b) providing a first aqueous hydrocolloid-containing composition comprising multi-sulphated carrageenan,
d) mixing the first aqueous phycocyanin-containing composition of step a) with the aqueous hydrocolloid-containing composition of step b) at a pH of between 4.0 and 4.9, preferably between 4.5 and 4.9 to obtain a mixture having a weight ratio of multi-sulphated carrageenan to phycocyanin of between 0.05:1 and 0.9:1,
c) providing a second aqueous hydrocolloid-containing composition comprising another hydrocolloid,
e) adding the second aqueous hydrocolloid-containing composition of step c) to the mixture obtained in step d) to obtain a mixture having a weight ratio of multi-sulphated carrageenan to the other hydrocolloid of between 1:0.1 to 1:30 to obtain an aqueous phycocyanin- and hydrocolloid-containing composition, and
f) lowering the pH of the mixture obtained in step e) to a value of between 2.5 and 3.9, to obtain an acidic aqueous phycocyanin- and hydrocolloid-containing composition.

### Specific Embodiment 3

In this specific embodiment, the order of the steps is a), c), e), intermediate pH adjustment step, b), d), and f). Step a) comprises the provision of an aqueous phycocyanin-containing composition, step d) comprise the provision of a second aqueous hydrocolloid-containing composition comprising another hydrocolloid (not being multi-sulphated carrageenan), step e) comprises mixing these two compositions, then an intermediate step of increasing the pH to a value of between 4.0 and 4.9, preferably between 4.5 and 4.9, then step b) comprising the provision of a first aqueous hydrocolloid-containing composition comprising multi-sulphated carrageenan, step d) comprises adding the first aqueous hydrocolloid-containing composition of step b) to the mixture obtained after the intermediate step and step f) comprises lowering the pH.

This embodiment thus discloses the following method according to the invention: a method comprising the steps of:
a) providing an aqueous phycocyanin-containing composition having a phycocyanin concentration of between 0.05 and 50 wt. %, based on the weight of the aqueous phycocyanin-containing composition, optionally further comprising chitosan in a weight ratio of phycocyanin to chitosan of between 1:1 and 7:1, preferably between 1.5:1 and 5:1;
c) providing a second aqueous hydrocolloid-containing composition comprising another hydrocolloid,
e) adding the second aqueous hydrocolloid-containing composition of step c) to the aqueous phycocyanin-containing composition of step a) to obtain a mixture, and,
intermediate step) adjusting the pH of the mixture obtained in step e) to a value of between 4.0 and 4.9, preferably between 4.5 and 4.9 to obtain a pH-adjusted mixture,
b) providing a first aqueous hydrocolloid-containing composition comprising multi-sulphated carrageenan,
d) mixing the pH-adjusted mixture of the intermediate step with the aqueous hydrocolloid-containing composition of step b) at a pH of between 4.0 and 4.9, preferably between 4.5 and 4.9 to obtain a mixture having a weight ratio of multi-sulphated carrageenan to phycocyanin of between 0.05:1 and 0.9:1 and a weight ratio of multi-sulphated carrageenan to the other hydrocolloid of between 1:0.1 to 1:30,
f) lowering the pH of the mixture obtained in step e) to a value of between 2.5 and 3.9, to obtain an acidic aqueous phycocyanin- and hydrocolloid-containing composition.

### Specific Embodiment 4

In this specific embodiment, the order of steps is a), b), d), f), c), and e). Step a) comprises the provision of an aqueous phycocyanin-containing composition, step b) comprise the provision of a providing a first aqueous hydrocolloid-containing composition comprising multi-sulphated carrageenan, step d) comprises mixing these two compositions, step f) comprises lowering the pH, step c) comprises providing a second aqueous hydrocolloid-containing composition comprising another hydrocolloid, and step d) comprises mixing the composition of step c) with the mixture obtained in step f).

This embodiment thus discloses the following method according to the invention: a method comprising the steps of:
a) providing an aqueous phycocyanin-containing composition having a phycocyanin concentration of between 0.05 and 50 wt. %, based on the weight of the aqueous phycocyanin-containing composition, optionally further comprising chitosan in a weight ratio of phycocyanin to chitosan of between 1:1 and 7:1, preferably between 1.5:1 and 5:1,
b) providing a first aqueous hydrocolloid-containing composition comprising multi-sulphated carrageenan,
d) mixing the first aqueous phycocyanin-containing composition of step a) with the aqueous hydrocolloid-containing composition of step b) at a pH of between 4.0 and 4.9, preferably between 4.5 and 4.9 to obtain a mixture having a weight ratio of multi-sulphated carrageenan to phycocyanin of between 0.05:1 and 0.9:1,
f) lowering the pH of the mixture obtained in step d) to a value of between 2.5 and 3.9, to obtain an acidic mixture,
c) providing a second aqueous hydrocolloid-containing composition comprising another hydrocolloid,
e) adding the second aqueous hydrocolloid-containing composition of step c) to the acidic mixture obtained in step f) to obtain an aqueous phycocyanin- and hydrocolloid-containing composition having a weight ratio of multi-sulphated carrageenan to hydrocolloid of between 1:0.1 to 1:30 to obtain.
   Optional and Additional Steps to be Carried Out after the Steps Above.

There are several optional steps such as concentration and/or pasteurization and/or drying.

### Concentration Step

Concentration (which may be denoted as step g) is an optional step and relates to concentrating the phycocyanin- and hydrocolloid-containing composition or the acidic the phycocyanin- and hydrocolloid-containing composition. With this step a concentrated phycocyanin- and hydrocolloid-containing composition is obtained having a solids concentration of between 2 and 50 wt. % of solids, or between 2 and 40 wt. % of solids, based on the concentrated phycocyanin- and hydrocolloid-containing composition.

The main object of the present invention is to provide aqueous composition which have optimal nutritional properties as well as colour value. For certain applications it is desirable to concentrate the aqueous composition. The aqueous composition can be concentrated for example by reverse osmosis, a falling film evaporation or rotary evaporation to increase the concentration. In an embodiment, the concentration step is carried out at a temperature of between 520 and 50 °C for a duration of between 1 and 8 hours.

Concentration step is preferred when the starting concentration of phycocyanin is low.

### Pasteurization Step

Pasteurization (which may be denoted by step h) is an optional step and relates to pasteurizing the phycocyanin- and hydrocolloid-containing composition or the acidic phycocyanin- and hydrocolloid-containing composition. This may also be carried out before or after the concentration step discussed above or the drying step discussed below. This is carried out at a temperature of between 60 and 95 °C for a period of time of at least 15 seconds, preferably at least 30 seconds.

Pasteurization of the composition has the advantage that it prolongs shelf life. Since pasteurization not only destroys pathogenic micro-organism, but also the beneficial bacteria, pasteurization is a way to make the high nutritional composition of the invention available to people and animals intolerant to probiotics.

The other hydrocolloid that is used was found by the present inventors to increase the stability of the colour of a composition undergoing heat treatment. With the present invention even after pasteurizing a composition is obtained that has a stable colour value, in other words, the composition is pasteurizable.

### Drying

Drying (which may be noted as step i) is an optional step and relates to drying the phycocyanin- and hydrocolloid-containing composition or the acidic phycocyanin- and hydrocolloid-containing composition to a water concentration of at most 15 wt. %, based on the weight of the dried phycocyanin- and hydrocolloid-containing composition. This may also be carried out before or after the concentration step or the pasteurization step discussed above.

The aqueous composition can be dried for example by spray-drying, drum drying or freeze-drying. In an embodiment, the drying step is carried out at a temperature of between 1 and 140 °C for a duration of between 1 and 24 hours.

### Aqueous Phycocyanin- and Carrageenan-Containing Composition.

In an aspect, the invention relates to an aqueous phycocyanin- and carrageenan-containing composition, comprising:
between 40 and 99 wt. % of water, preferably between 65 and 98 wt. %,
between 0.05 and 55 wt. % of phycocyanin,
multi-sulphated carrageenan in a weight ratio of multi-sulphated carrageenan to phycocyanin of between 0.05:1 and 0.9:1, preferably between >0.35:1 and 0.9:1
another hydrocolloid in a weight ratio of multi-sulphated carrageenan to the other hydrocolloid of between 1:0.1 to 1:30,
optionally chitosan in a weight ratio of phycocyanin to chitosan of between 1:1 and 7:1, preferably between 1.5:1 and 5:1,
said composition having: a pH of between 2.5 and 3.9, preferably between 2.8 and 3.6.

The sum of all these components adds up to 100 wt. % and each of these weight percentages cited are on basis of the total weight of the aqueous composition. The aqueous composition according to the present invention may be used as such or may subjected to one or more additional steps as shown above.

The present composition is a highly nutritional, highly nourishing composition, which can be used as or in food stuff, cosmetics, and skin care products. The composition of the invention may be an edible composition, that is safe for consumption and based on edible starting material. The present invention is related to non-toxic compositions. Examples are beverages, such as soft drinks, alcoholic beverages, shakes, juices, milk preparations; jellies, jams, sauces, baked goods, fortifications for plant-based meat or fish alternatives.

The preferred weight ratio of a multi-sulphated carrageenan to phycocyanin of can depend on the water content of the mixture obtained (the aqueous phycocyanin- and hydrocolloid-containing composition).

### Dried Phycocyanin- and Carrageenan-Containing Composition.

In an aspect, the invention relates to a dried phycocyanin- and carrageenan-containing composition, comprising:
between 1 and 15 wt. % of water
between 2 and 90 wt. % of phycocyanin,
multi-sulphated carrageenan in a weight ratio of multi-sulphated carrageenan to phycocyanin of between 0.05:1 and 0.9:1, preferably between 0.05:1 and 0.35:1
another hydrocolloid in a weight ratio of multi-sulphated carrageenan to the other hydrocolloid of between 1:0.1 to 1:30,
optionally chitosan in a weight ratio of phycocyanin to chitosan of between 1:1 and 7:1, preferably between 1.5:1 and 5:1,
   said composition having a pH of between 2.5 and 3.9, preferably between 2.8 and 3.6.

In an embodiment, the dried phycocyanin- and carrageenan containing composition comprises less than 15 wt. % or less than 10 wt. % of water.

The sum of all these components adds up to 100 wt. % and each of these weight percentages cited are on basis of the total weight of the dried composition. The dried composition according to the present invention may be used as such or may subjected to one or more additional steps as shown above.

The present composition is a highly nutritional, highly nourishing composition, which can be used as or in food stuff, cosmetics, and skin care products. The composition of the invention may be an edible composition, that is safe for consumption and based on edible starting material. The present invention is related to non-toxic compositions.

The preferred weight ratio of a multi-sulphated carrageenan to phycocyanin of can depend on the water content of the mixture obtained (the aqueous phycocyanin- and hydrocolloid-containing composition). This is discussed above.

### Method of Preparing a Food Composition

In an aspect, the invention relates to a method of preparing a food composition by mixing the phycocyanin- and hydrocolloid-containing composition according to the invention or obtained according to the method according to the invention with one or more diluents selected from the group consisting of water, milk, plant-based milk, and juices and/or one or more further ingredients selected from the group consisting of flavouring agents, fibers, inulins, chelating agents, spices, emulsifiers, hydrocolloids, herb extracts, vitamins, and minerals, to a concentration of phycocyanin of between 0.001 and 20 wt. %, optionally diluting with water, optionally adjusting the pH, to achieve a composition having a pH of between 2.5 and 3.9.

The ingredients used are ingredients known in the field.

### Food Composition

In an aspect, the present invention relates to a food composition comprising the phycocyanin- and hydrocolloid-containing composition according to the invention or obtained according to invention, having a concentration of phycocyanin of between 0.001 and 20 wt. %, having a pH of between 2.5 and 3.9, and optionally further comprising milk, plant-based milk, juices, flavours, chelating agents, spices, emulsifiers, hydrocolloids, herb extracts, vitamins, minerals, etc.

The ingredients used are ingredients known in the field. The present food composition is highly nutritional and highly nourishing. The composition of the invention is safe for consumption and based on edible starting material. The present invention is related to non-toxic compositions.

It was also found that the composition is a healthy alternative “food to go”, a food product that is ready to consume and can easily be transported to the place of consumption. The composition may be consumed at different temperatures without any loss of taste.

The preferred weight ratio of a multi-sulphated carrageenan to phycocyanin depends on the water content of the mixture obtained (the aqueous phycocyanin- and hydrocolloid-containing composition). This is discussed above.

The main object of the present invention is to provide aqueous composition which have optimal nutritional properties as well as colour value. Although not preferred it is also possible to (fully) dry the composition. The thus obtained dried composition was found to be very stable and suitable for use in various food and feed products.

### Colour Value

In an embodiment, said compositions of the invention have a colour value according to the CIELAB Colour scale for the a-value of between −20 and 10 and for the b-value of between 10 and −40 at a dry weight of the composition of between 0.1 and 10 wt. %. With higher levels of solid matter (higher dry weight), viz. concentration, the CIELAB values will differ. The CIELAB Colour values were determined using a Hunterlab Ultrascan VIS. Without wishing to be bound by a particular theory, the present inventors believe that by using the present process, the colour stability is increased. In addition, the phycocyanin is not isolated from its natural environment and by keeping other cell components, the colour stability of the phycocyanin is increased. This is an advantage obtained by the method according to the present invention. The colour value is stable even at temperature of pasteurization. In an embodiment, the colour is stable at pH between 8 and 2.5. In an embodiment, said dried composition is prepared from an aqueous composition having a colour value as discussed for the aspect of the method above. The colour value may be stable for at least 4 months, preferably at least 12 months.

### Effects of the Invention

The present invention focuses on the optimum pH value during the mixing process as well as the optional ratios of hydrocolloids to phycocyanin, both of which can be used to trigger a strong stabilization process of phycocyanin compositions, mixed with carrageenan and another hydrocolloid. This process ensures an improved colour (stability), improved phase stability and improved processability compared to the prior art processes, especially for applications requiring low pH and/or high temperature.

In view of the pH value during stabilization, the prior art processes focus on repulsive electrostatic interactions between phycocyanin and carrageenan, which interactions are triggered at pH values of above 5 during the stabilization process (during the mixing of carrageenan and phycocyanin). Since that is the pH values used by all prior art processes, this prevents the prior art processes from achieving phase stabilization during the stabilization process and prevents the liquid extracts being acidified right after stabilization (since that would lead to decrease in colour). This is a clear technical effect and advantage of the present invention. The present inventors have observed-without wishing to be bound to any particular theory, that acidifying to a lower pH (pH<5) after repulsive stabilization has occurred (pH>5) according to the prior art does not work at this type of interactions. The inventors believe that this is because the pH drop changes the electrostatic charge of the phycocyanin causing associative phase separation in the composition. Due to the unavailability to lower the pH and maintain the stability at the same time, prior art extracts are not shelf stable at room temperature in liquid format since the compositions need to be stored at pH>5 which would, at room temperature, lead to the risk of microbial growth. Therefore, these compositions according to the prior art need to be stored refrigerated which is a disadvantage.

The method according to the present invention focuses, according to the believe of the present inventors, on attractive interactions between phycocyanin and carrageenan (instead of repulse interactions) forcing individual phycocyanin molecules to deposit separately along the polysaccharides chains of carrageenan; which the inventors have found out is only possible to occur at lower pH (between 4.0 and 4.9, preferably between 4.5 and 4.9). The attractive interaction is found to be more stable than the repulsive interaction and it is maintained when the pH of the mixture is brought to low pH environments (pH<4). In other words, the composition according to the present invention is more stable at low pH than the prior art compositions, and, therefore, conserving the composition at lower pH is possible, which is better to avoid microbial growth and allows storage at room temperature without risk of microbial growth.

In view of the hydrocolloid ratios, the following may be observed. The prior art methods focus on a high ratio of carrageenan to phycocyanin to ensure a certain colour and phase stability. The present inventors have observed that these high ratios have some disadvantages due to the high viscosity and foam formation capacity and stability. This makes it that these prior art compositions are not easy to package (can or bottle) in case of a drink, especially in case of carbonated beverages, causing foam formation. In addition, the prior art compositions are not efficient to dry to a dried composition, because a skilled person would know that most common commercial drying technologies require that prior to drying the composition should have a certain viscosity threshold to allow dry weight concentration up to 20 wt. %-40%. If previous concentration dry weight concentration is lower than that, drying becomes very inefficient yielding high energy consumption and costs. The present invention provides a solution to these problems by using a method having lower ratios of carrageenan to phycocyanin while still be able to provide optimal stability because of the use of low pH combined with another hydrocolloid.

The present invention provides a method to stabilize phycocyanin containing compositions at low pH levels (pH<5) ensuring phase and colour stability and keeping a shelf stable aqueous phycocyanin containing composition before drying. The present invention provides an easy to process phycocyanin composition. The present invention provides an easy to carbonate or/and can or bottle in a commercial setting in a beverage format. The present invention provides an easy to dry due to the lower viscosity and foam formation. The effects of the presence of chitosan are discussed above.

Concluding, the present inventors have inventively observed that, when compared to prior art methods and products, the present method and (food) compositions allows to stabilize the colour for a wide range of pH values and temperatures.

### EXAMPLES

The present invention is further elucidated based on the Examples below which are illustrative only and not considered limiting to the present invention.

### Materials

Diluted phycocyanin extract was obtained from FUL Foods having a phycocyanin content of 0.20 wt. %, and a total protein content of 1.0 wt. %. The phycocyanin extract does not comprise a hydrocolloid, such as pectin or carrageenan. Demineralized water was obtained from Boom Laboratory supplier. As carrageenan lambda carrageenen of the type GENUVISCO® (type CSM-2) as a powder was obtained from CPKelco. As pectin a citrus pectin was used of the type: instant CJ 204 which was obtained from Herbstreith&Fox GmbH. As a first type of gum, Arabic gum of the type: BEV-202 as a powder was obtained from Ingredion. As a second type of gum, Xanthan gum of the type Keltrol V was obtained from CPKelco. As a plant-based milk, a commercially available plant-based milk, Oatly® barista edition was used.

### Methods

### Absorption Spectrometry to Determine Colour Stability of Phycocyanin.

The blue colour of a composition is measured using absorption spectroscopy, measuring the amount of light that is absorbed at specific wavelengths. The present invention uses the total sum of blue colour absorbance. With “total sum of blue colour absorbance” is meant within the context of the present description the sum of the respective difference in absorbance between wavelengths 667 nm, 650 nm and 620 nm with a wavelength of 750 nm, according to the equation below.

total sum of blue absorbance=(A620−A750)+(A650−A750)+(A667−A750)

wherein A620 is the absorbance at a wavelength of 620 nanometer, wherein A750 is the absorbance at a wavelength of 750 nanometer, wherein A650 is the absorbance at a wavelength of 650 nanometer, and wherein A667 is the absorbance at a wavelength of 667 nanometer.

The total sum of blue absorbance before heat-treatment is set to 100%. The colour stability (in %) is calculated as a percentage using the equation below, a percentage of 100% being completely stable.

$$color stability = \frac{total sum of blue absorbance after heat treatment}{total sum of blue absorbance before heat treatment} \times 100 \%$$

### Visual Determination of Phase Stability and Colour Appearance.

The colour appearance and phase stability of each sample was visually determined. Any phase separation and/or sedimentation has a direct influence on the values obtained in absorption spectrometry and therefore has to be ascertained prior to absorption spectroscopy.

The visual determination of the samples is to determine which samples displayed separation and sedimentation after for example pH adjustment and/or heat treatment. Any samples that showed either phase separation or sedimentation were centrifuged for a period of 10 minutes at centrifugation speed of 6000 rpm, after which the supernatant was removed from any sediment; the total sum of blue colour absorbance was measured only on the obtained supernatant. In case of no phase separation the total blue colour absorbance was measured by diluting the samples to the required concentration ranges for the measurement. The obtained results were normalized for the respective dilutions to be within the required concentrations range for the absorbance measurements.

### Overview of Examples

The following examples have been carried out. In order to study the effect of the method of the present invention first the colour and phase stability after heat treatment (pasteurization) of an acidic aqueous phycocyanin- and hydrocolloid-containing composition having a pH of 3.5 according to the invention (Example 1) was compared to a phycocyanin-containing composition having a pH of 3.5 without carrageenan or any other type of hydrocolloid (Comparative Example 1).

Second, the colour and phase stability after two types of heat treatment, pasteurization and accelerated shelf life testing respectively, of an acidic aqueous phycocyanin- and hydrocolloid-containing composition having a pH of 3.5, comprising a pectin (Example 2.1) according to the invention, and an acidic aqueous phycocyanin- and hydrocolloid-containing composition having a pH of 3.5, comprising a gum (Example 2.2) according to the invention, were compared to a phycocyanin-containing composition having a pH of 3.5 comprising only carrageenan but not any other type of hydrocolloid (Comparative Example 2).

Third, the phase stability after heat treatment (pasteurization) and addition of plant-based milk of an acidic aqueous phycocyanin- and hydrocolloid-containing composition having a pH of 3.5 according to the invention (Example 3 as Example 1) was compared to a phycocyanin-containing composition having a pH of 3.5 without carrageenan or any other type of hydrocolloid (Comparative Example CE3.1 as Comparative Example 1), as well as to a phycocyanin-containing composition having a pH of 3.5 comprising only carrageenan but not any other type of hydrocolloid (Comparative Example CE3.2 as Comparative Example 2).

Fourth, the viscosity, foaming performance, and phase stability after heat treatment (pasteurization) of an acidic aqueous phycocyanin- and hydrocolloid-containing composition having a pH of 3.5 according to the invention (Example 4 as Example 1) was compared to a phycocyanin-containing composition having a pH of 3.5 comprising only carrageenan but not any other type of hydrocolloid (Comparative Example CE4 as Comparative Example CE2).

Fifth, the colour and phase stability before and after heat treatment (pasteurization) and accelerated shelf life testing, of an acidic aqueous phycocyanin- and hydrocolloid-containing composition having a pH of 3.25, comprising an hydrated gellan gum according to the invention (Example 5). Results were compared to a phycocyanin-containing composition having a pH of 4.0 comprising only carrageenan but not any other type of hydrocolloid (Comparative Example 5).

### (Comparative) Example 1

### Preparation of Phycocyanin- and Hydrocolloid Containing Composition

### Example 1 (E1)

80 grams of diluted phycocyanin extract was used. The pH was adjusted to 4.8 (using sodium citrate). This is the step of providing an aqueous phycocyanin-containing composition of the present method.

Thereafter, 4 grams of an aqueous carrageenan composition comprising 4 wt. % of lambda carrageenan in demi-water were added. The carrageenan composition was prepared by dissolving 4 gram of lambda carrageenan powder in 100 mL of demi-water at a temperature of 20 °C and mixed using an ULTRA-TURRAX® homogenizer with a stirring speed of 10-12 rpm (×1000) and a duration of 10-15 minutes to obtain a thoroughly homogenous composition. This is the step of providing an aqueous hydrocolloid-containing composition comprising multi-sulphated carrageenan of the present method.

Thereafter, 12 grams of an aqueous xanthan gum composition comprising 1 wt. % of xanthan gum in demi-water. The xanthan gum composition was prepared by dissolving 1 gram of xanthan gum powder in 100 mL of demi-water at a temperature of 20 °C and mixed using an ULTRA-TURRAX® homogenizer with a stirring speed of 10-12 rpm (×1000) and a duration of 10-12 minutes to obtain a homogenous solution. This is the step of providing an aqueous hydrocolloid-containing composition comprising multi-sulphated carrageenan and another hydrocolloid.

The aqueous phycocyanin-containing starting composition was mixed first with the aqueous carrageenan solution and then with the xanthan gum solution to achieve a homogeneous mixture having a ratio of lambda carrageenan to phycocyanin of 1:0.8 and a ratio of lambda carrageenan to xanthan gum of 1:0.6. This is the step of mixing the aqueous phycocyanin-containing composition with the aqueous hydrocolloid-containing compositions of the present method.

The pH of the mixture obtained was adjusted to 3.5 using a mild food-grade acid, being citric acid. This is the step of lowing the pH of the mixture to obtain an acidic aqueous phycocyanin- and hydrocolloid-containing composition of the present method.

### Comparative Example 1 (CE1)

80 grams of diluted phycocyanin extract was used. No carrageenan or other hydrocolloids were added. The pH was adjusted to pH 3.5 using citric acid.

### Heat Treatment

The compositions obtained above for E1 and CE1 were subjected to a heat treatment with the objective of pasteurisation at a temperature between 75 °C and 80 °C for a duration between 2 and 5 minutes.

### Colour Stability of Phycocyanin Using Absorption Spectrometry

To determine the phycocyanin colour stability with hydrocolloid treatment (E1) and without hydrocolloid treatment (CE1) the total sum of blue colour absorbance in the sample was measured before heat treatment, and after heat treatment.

### Colour Appearance and Phase Stability of Phycocyanin Using Visual Determination.

The colour appearance and phase stability of each sample was visually determined before heat treatment, and after heat treatment, since any decrease in phase stability (phase separation and/or sedimentation) has a direct influence on the values obtained in spectrometry for the total sum of blue colour absorbance measurements.

### Results for (Comparative) Example 1

The tables below show the results for E1 and CE1. Table 1 shows the visual determination of phase stability. Table 2 shows the visual determination of colour appearance. Tables 3 and 4 show the values for absorption spectroscopy, the total sum of blue absorbance as well as the calculated colour stability (%).

TABLE 1
visual determination of phase stability
of compositions of E1 and CE1

| Example | E1 | CE1 |
|---|---|---|
| Before heat | Homogenous liquid, no | Immediate phase |
| treatment | sediment | separation* |
| After heat | Homogenous liquid, no | Phase separation and |
| treatment | sediment | formation of sediment |

*Immediate phase separation is meant as clear particle sedimentation 1 hour after the treatment.

From this visual appearance it is clear that the present invention shows a significant effect on phase stabilization of phycocyanin-containing aqueous compositions at low pH. This stabilization is maintained after heat treatment (pasteurization). The comparative example shows phase separation and formation of sediment, whereas the example according to the invention shows a completely homogeneous liquid without any sedimentation or layer formation.

TABLE 2
visual determination of colour appearance
for compositions of E1 and CE1

| Example | E1 | CE1 |
|---|---|---|
| Before heat | Blue homogeneous | Clear blue liquid + blue |
| treatment | colour | sediment |
| After heat | Blue homogeneous | Clear blue/green liquid + green |
| treatment | colour | sediment and floating particles |

From this visual appearance it is clear that the present invention shows a significant effect on colour stabilization of phycocyanin-containing aqueous compositions at low pH. This stabilization is maintained after heat treatment (pasteurization). After heat treatment (pasteurization) the example according to the invention shows a blue colour, whereas the comparative example shows a blue/green colour.

TABLE 3
absorption spectroscopy

| Example | E1 | CE1 | E1 | CE1 | E1 | CE1 | E1 | CE1 | E1 | CE1 |
|---|---|---|---|---|---|---|---|---|---|---|
| Absorb. | 620 | | 650 | | 667 | | 750 | | Total sum | |
| value* | | | | | | | | | of blue | |
| (in AU) | | | | | | | | | absorbance | |
| Before | 11.034 | 11.668 | 5.371 | 3.342 | 2.727 | 1.020 | 0.597 | −0.361 | 17.342 | 17.113 |
| heat | | | | | | | | | | |
| treatment | | | | | | | | | | |
| After heat | 4.095 | 0.074 | 4.487 | 0.06 | 4.409 | 0.045 | 1.577 | 0.017 | 8.259 | 0.129 |
| treatment | | | | | | | | | | |

TABLE 4
colour stability.

| Example | E1 | CE1 |
|---|---|---|
| Before heat treatment | 100% | 100% |
| After heat treatment | 47.6% | 0.75% |

From this absorption spectroscopy it is clear that the present invention shows a significant effect on colour stabilization of phycocyanin-containing aqueous compositions at low pH. This stabilization is maintained to a much higher degree after pasteurization (47.6%) compared to the comparative example (0.75%).

Summarizing, this clearly shows that the addition of carrageenan and another hydrocolloid according to the inventive method achieves one or more of the objects of the invention, namely increased colour stability of an aqueous phycocyanin-containing composition at low pH and increased phase stability at low pH.

### (Comparative) Example 2

### Preparation of Phycocyanin- and Hydrocolloid Containing Composition

### Example 2-1 (E2-1)

80 grams of diluted phycocyanin extract was used. The pH was adjusted to 4.8 (using sodium citrate). This is the step of providing an aqueous phycocyanin-containing composition of the present method.

Thereafter, 4 grams of an aqueous carrageenan solution comprising 4 wt. % of lambda carrageenan in demi-water was provided (preparation as discussed above).

Thereafter, 16 grams of an aqueous citrus-pectin solution comprising 4 wt. % of citrus pectin in demi-water was provided. The pectin solution was prepared by dissolving 4 grams of citrus pectin powder in 100 mL of demi-water at a temperature of 20 °C and mixed using an ULTRA-TURRAX® homogenizer with a stirring speed of 10-12 rpm (×1000) and a duration of 8-10 minutes to obtain a homogenous solution. This is the step of providing one or more aqueous hydrocolloid-containing compositions of the present method.

The aqueous phycocyanin-containing starting composition was mixed first with the aqueous carrageenan solution and then with the citrus pectin solution to achieve a homogeneous mixture having a ratio of lambda carrageenan to phycocyanin 0.8:1 and lambda carrageenan to pectin of 1:4. This is the step of mixing the aqueous phycocyanin-containing composition with the aqueous hydrocolloid-containing compositions of the present method.

The pH of the mixture obtained was adjusted to 3.5 using a mild food-grade acid, being sodium citrate. This is the step of lowering the pH of the mixture to obtain an acidic aqueous phycocyanin- and hydrocolloid-containing composition of the present method.

### Example 2-2 (E2-2)

80 grams of diluted phycocyanin extract was used. The pH was adjusted to 4.8 (using sodium citrate). This is the step of providing an aqueous phycocyanin-containing composition of the present method.

Thereafter, 4 grams of an aqueous carrageenan solution comprising 4 wt. % of lambda carrageenan in demi-water was provided (preparation discussed above).

Thereafter, 16 grams of an aqueous Arabic gum solution comprising 30 wt. % of Arabic gum in demi-water was provided. The Arabic gum solution was prepared by dissolving 30 gram of Arabic gum powder in 100 mL of demi-water at a temperature of 20 °C and mixed using an ULTRA-TURRAX® homogenizer with a stirring speed of 10-12 rpm (×1000) and a duration of 5-8 minutes to obtain a homogenous solution. This is the step of providing an aqueous hydrocolloid-containing composition comprising another hydrocolloid.

The aqueous phycocyanin-containing starting composition was mixed first with the aqueous carrageenan solution and then with the Arabic gum solution to achieve a homogeneous mixture having a ratio of lambda carrageenan to phycocyanin 0.8:1 and lambda carrageenan to gum Arabic of 1:30. This is the step of mixing the aqueous phycocyanin-containing composition with the aqueous hydrocolloid-containing composition of the present method.

The pH of the mixture obtained was adjusted to 3.5 using a mild food-grade acid, being sodium citrate. This is the step of lowering the pH of the mixture to obtain an acidic aqueous phycocyanin- and hydrocolloid-containing composition.

### Comparative Example 2 (CE2)

80 grams of diluted phycocyanin extract was used. The pH was adjusted to 4.8 (using sodium citrate). This is the step of providing an aqueous phycocyanin-containing composition of the present method.

Thereafter, 20 grams of an aqueous carrageenan solution comprising 4 wt. % of lambda carrageenan in demi-water was provided (preparation as discussed above).

The aqueous phycocyanin-containing starting composition was mixed with the aqueous carrageenan solution to achieve a homogeneous mixture having a ratio of lambda carrageenan to phycocyanin 1:0.25.

The pH of the mixture obtained was adjusted to 3.5 using a mild food-grade acid, being citric acid.

### Heat Treatment

The compositions obtained above for E2-1, E2-2 and CE2 were subjected to two different types of heat treatment. The first being pasteurization at a temperature between 75 °C and 80 °C for a duration of between 2 and 5 minutes. The second heat treatment was an accelerated shelf-life testing on a VOS Instrumenten incubator type VOS-12022 that is maintained at a temperature of between 44 and 46 °C for 5 days.

### Colour Stability of Phycocyanin Using Absorption Spectrometry

To determine the phycocyanin colour stability of E2-1, E2-2 and CE2 the total sum of blue colour absorbance in the sample was measured at several instances during the method, being i) before heat treatment, ii) after pasteurization, iii) after incubation for 5 days.

### Colour Appearance and Phase Stability of Phycocyanin Using Visual Determination.

The colour appearance and phase stability of each sample was visually determined at several instances during the method, being i) before heat treatment, ii) after pasteurization, iii) after incubation for 5 days.

### Results for (Comparative) Example 2

The tables below show the results for E2-1, E2-2 and CE2. Table 9 shows the visual determination of phase stability. Table 10 shows the visual determination of colour appearance. Tables 11 and 12 show the values for absorption spectroscopy, the total sum of blue absorbance as well as the calculated colour stability.

TABLE 9
visual determination of phase stability
of compositions of E2-1, E2-2 and CE2

| Example | E2-1 | E2-2 | CE2 |
|---|---|---|---|
| Before heat | Homogenous | Homogenous | Homogenous |
| treatment | liquid, no | liquid, no | liquid, no |
| | sediment | sediment | sediment |
| After | Homogenous | Homogenous | Homogenous |
| pasteurization | liquid, no | liquid, no | liquid, no |
| | sediment | sediment | sediment |
| After | Homogenous | Homogenous | Homogenous |
| incubation for | liquid, no | liquid, no | liquid, no |
| 5 days | sediment | sediment | sediment |

From this visual appearance it is clear that both the examples according to the present invention and the comparative example shows phase stabilization of phycocyanin-containing aqueous compositions at low pH. This stabilization is maintained after pasteurization.

TABLE 10
visual determination of colour appearance
for compositions of E3-1, E3-2 and CE3

| Example | E2-2 | E2-2 | CE2 |
|---|---|---|---|
| After | Blue | Blue | Blue |
| pasteurization | homogeneous | homogeneous | homogeneous |
| | colour | colour | colour |
| After | Blue | Blue | Blue-green |
| incubation for | homogeneous | homogeneous | colour |
| 5 days | colour | colour | |

From this visual appearance it is clear that the present invention shows a significant effect on colour stabilization of phycocyanin-containing aqueous compositions at low pH. This stabilization is maintained after pasteurization and upon incubation for 5 days. The comparative example shows faster deterioration in colour after incubation during 5 days.

TABLE 11
absorption spectroscopy

| Example | E2-1 | CE2 | E2-1 | CE2 | E2-1 | CE2 | E2-1 | CE2 | E2-1 | CE2 |
|---|---|---|---|---|---|---|---|---|---|---|
| Absorbance | 620 | | 650 | | 667 | | 750 | | Total sum | |
| value* | | | | | | | | | | |
| (in AU) | | | | | | | | | | |
| After | 0.503 | 0.36 | 0.491 | 0.35 | 0.470 | 0.34 | 0.228 | 0.12 | 0.78 | 0.69 |
| pasteurization | | | | | | | | | | |
| After | 0.45 | 0.29 | 0.43 | 0.28 | 0.41 | 0.27 | 0.22 | 0.10 | 0.63 | 0.52 |
| incubation | | | | | | | | | | |
| at 45 C for 5 | | | | | | | | | | |
| days | | | | | | | | | | |

TABLE 12
absorption spectroscopy

| Example | E2-2 | CE2 | E2-2 | CE2 | E2-2 | CE2 | E2-2 | CE2 | E2-2 | CE2 |
|---|---|---|---|---|---|---|---|---|---|---|
| Absorbance | 620 | | 650 | | 667 | | 750 | | Total sum | |
| value* (in AU) | | | | | | | | | | |
| After | 0.62 | 0.36 | 0.55 | 0.35 | 0.55 | 0.34 | 0.30 | 0.12 | 0.81 | 0.69 |
| pasteurization | | | | | | | | | | |
| After incubation | 0.76 | 0.29 | 0.72 | 0.28 | 0.68 | 0.27 | 0.47 | 0.10 | 0.76 | 0.52 |
| at 45 C for 5 days | | | | | | | | | | |

TABLE 13
colour stability.

| Example | E2-1 | E2-2 | CE2 |
|---|---|---|---|
| After heat treatment | 100% | 100% | 100% |
| After incubation for 5 | 80.01% | 93.95% | 74.96% |
| days | | | |

From this absorption spectroscopy it is clear that the present invention shows a significant effect on colour stabilization of phycocyanin-containing aqueous compositions at low pH. This stabilization is maintained above 80% after incubation for 5 days (E2-1 80.01% and E2-2 93.93%) compared to the comparative example, which retains less than 75% blue colour stability after incubation for 5 days.

Summarizing, this clearly shows that the present method consisting of minimizing the amount of carrageenan in relation to phycocyanin and adding a second hydrocolloid increases the colour retention of the phycocyanin composition over higher amounts of carrageenan in relation to phycocyanin.

### (Comparative) Example 3

### Preparation of Phycocyanin- and Hydrocolloid Containing Composition in Plant-Based Milk Preparations

### Example 3 (E3)

Example 3 is prepared in the say way as E1 discussed above.

### Comparative Example 3-1 (CE3-1)

Comparative example 3-1 is prepared in the say way as CE1 discussed above.

### Comparative Example 3-2 (CE3-2)

Comparative example 3-2 is prepared in the say way as CE2 discussed above.

### Heat Treatment

The compositions obtained above for E3, CE3-1 and CE3-2 were subjected to a heat treatment with the objective of pasteurization at a temperature between 75 °C and 80 °C for a duration of between 2 and 5 minutes.

### Plant-Based Milk Addition

50 g of each of the above samples were mixed with 50 g of plant-based milk (oat) at a temperature of 60 °C. Manual stirring for 30 seconds was performed.

### Phase Stability of Phycocyanin Using Visual Determination.

The colour appearance and phase stability of each sample was visually determined before and after addition of plant-based milk into the mix.

### Results for (Comparative) Example 3

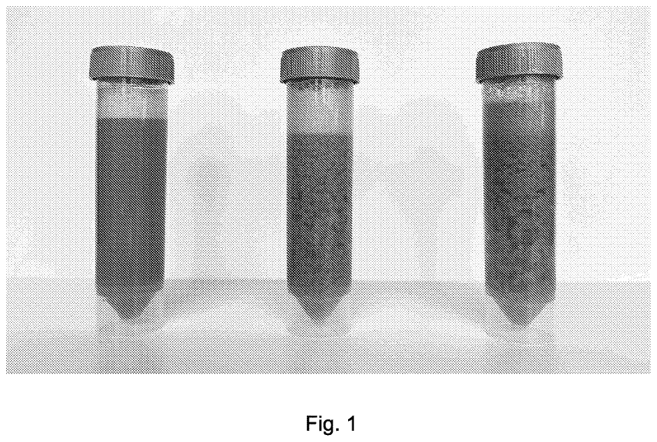

The table and picture below show the results for E3 with CE3-1 and CE3-2. Table 14 shows the visual determination of phase stability. FIG. 1 shows the visual effects.

TABLE 14
visual determination of phase stability
of compositions of E4, CE4-1 and CE4-2

| Example | E3 | CE3-1 | CE3-2 |
|---|---|---|---|
| Before plant- | Homogenous liquid, | Immediate phase | Immediate phase |
| based milk | no sediment | separation* | separation* |
| addition | | | |
| After plant- | Homogenous liquid, | Immediate phase | Immediate phase |
| based milk | no sediment | separation* | separation* |
| addition | | | |

*Immediate phase separation is meant as clear particle sedimentation 30 s after the treatment.

FIG. 1 shows a picture depicting three vials containing from left to right compositions E3, CE3-1 and CE3-2, respectively after the addition of the plant-based milk. The composition E3, in the left vial, is a homogenous liquid, with no sediment. In contrast compositions CE3-1 and CE3-2 in the middle and right vial, respectively show particle sedimentation.

Summarizing, this clearly shows that the present method consisting of minimizing the amount of carrageenan in relation to phycocyanin and adding a second hydrocolloid increases the phase stability and avoids curdling effects when mixed in plant-based milk preparations.

### (Comparative) Example 4

### Preparation of Phycocyanin- and Hydrocolloid Containing Composition and Foaming and Viscosity Characterization

### Example 4 (E4)

Example 4 is prepared in the say way as E1 above.

### Comparative Example 4 (CE4)

Comparative example 4 is prepared in the say way as CE2 above.

### Heat Treatment

The compositions obtained above for E4 and CE4 were subjected to a heat treatment with the objective of pasteurization at a temperature between 75 °C and 80 °C for a duration of between 2 and 5 minutes.

### Viscosity Measurement of Samples

The compositions obtained above for E4 and CE4 were subjected to a viscosity measurement using Cannon™-Fenske from Fisherbrand. 35 ml of sample E4 and CE4 were diluted with MiliQ water up to 50 ml in a cylindrical. Viscometer was used to measure the viscosity at a speed of 60 rpm.

### Foaming Performance and Stability Measurement of Samples

The compositions obtained above for E4 and CE4 were subjected to a foaming performance and stability measurement using an ULTRA TURRAX model T25 digital. 50 ml of sample E4 and CE4 were diluted with MiliQ water up to 200 ml in a cylindrical tube. Agitation was applied by ULTRATURRAX at a speed of 2 rpm (×1000) for 20 s. Volume of foam and volume of liquid were noted down immediately after agitation stopped and 30 minutes later.

Foaming performance was calculated by dividing the volume of foam by the volume of liquid immediately after agitation.

$$foaming performance = \frac{{V}_{F 0}}{{V}_{L 0}}$$

wherein V_{F0}=the volume of the foam directly after agitation (t=0 minutes) and
wherein V_{L0}=the volume of the liquid directly after agitation (t=0 minutes)

Foaming stability was calculated by dividing the volume of foam 30 minutes post agitation by the volume of foam immediately after agitation.

$$foaming stability = \frac{{V}_{F 30}}{{V}_{L 30}}$$

wherein V_{F30}=the volume of the foam 30 minutes after agitation (t=30 minutes) and
wherein V_{L30}=the volume of the liquid 30 minutes after agitation (t=30 minutes).

### Results for (Comparative) Example 4

The tables below show the results for E4 and CE4. Table 15 shows the viscosity determination and Table 16 shows the foaming performance and stability.

TABLE 15
viscosity determination of E4 and CE4

| Example | E4 | CE4 |
|---|---|---|
| Viscosity (mPa*s) | 4.24 mPa*s | 4.88 mPa*s |

TABLE 16
foaming capacity and stability determination of E4 and CE4

| Example | E4 | CE4 |
|---|---|---|
| Volume of liquid after agitation (t = 0 min) [V_{L0}] | 97 ml | 85 ml |
| Volume of foam after agitation (t = 0 min) [V_{F0}] | 15 ml | 109 ml |
| Foaming performance (%) | 15.5% | 128.2% |
| Volume of liquid after agitation (t = 30 min) [V_{L30}] | 99 ml | 96 ml |
| Volume of foam after agitation (t = 30 min) [V_{F30}] | 8 ml | 94 ml |
| Foaming stability (%) | 53.3% | 86.3% |

Summarizing, this clearly shows that the present method consisting of minimizing the ratio of carrageenan and adding a second hydrocolloid increases the processability by reducing foaming capacity of E4 vs CE4 from 128.2% to 15.5% and foaming stability of E4 vs CE4 from 86.3% to 53.3%. The present method also improved the processability into dried powder due to a significant viscosity reduction. Viscosity of CE4 is 15% higher than E4.

Although certain aspects of the invention have been described, the scope of the appended claims is not intended to be limited solely to these specific aspects. The claims are to be construed literally, purposively, and/or to encompass equivalents. The scope of the present invention is defined by the appended claims. One or more of the objects of the invention are achieved by the appended claims.

### (Comparative) Example 5

### Colour- and Phase Stabilization of an Aqueous Phycocyanin-Containing Composition at Low pH Using Gellan Gum

### Example 5 (E5)

80 grams of diluted phycocyanin extract was used. The pH was adjusted to 4.8 (using sodium citrate). This is the step of providing an aqueous phycocyanin-containing composition of the present method.

Thereafter, 4 grams of an aqueous carrageenan composition comprising 4 wt. % of lambda carrageenan in demi-water were added. The carrageenan composition was prepared by dissolving 4 gram of lambda carrageenan powder in 100 ml of demi-water at a temperature of 20 °C and mixed using an ULTRA-TURRAX® homogenizer with a stirring speed of 10-12 rpm (×1000) and a duration of 10-15 minutes to obtain a thoroughly homogenous composition. This is the step of providing an aqueous hydrocolloid-containing composition comprising multi-sulphated carrageenan of the present method.

Thereafter, 100 grams of an aqueous gellan gum composition comprising 1 wt. % of gellan gum in demi-water. The gellan gum composition was prepared by dissolving 1 gram of xanthan gum powder in 100 ml of demi-water at a temperature of 85 °C and mixed using an ULTRA-TURRAX® homogenizer with a stirring speed of 10-12 rpm (×1000) and a duration of 10-12 minutes to obtain a homogenous solution. This is the step of providing an aqueous hydrocolloid-containing composition comprising multi-sulphated carrageenan and another hydrocolloid.

The aqueous phycocyanin-containing starting composition was mixed first with the aqueous carrageenan solution and then with the gellan gum solution to achieve a homogeneous mixture having a ratio of lambda carrageenan to phycocyanin of 1:1.25 and a ratio of lambda carrageenan to gellan gum of 1:0.53. This is the step of mixing the aqueous phycocyanin-containing composition with the aqueous hydrocolloid-containing compositions of the present method.

The pH of the mixture obtained was adjusted to 3.25 using a mild food-grade acid, being citric acid. This is the step of lowing the pH of the mixture to obtain an acidic aqueous phycocyanin- and hydrocolloid-containing composition of the present method.

### Comparative Example 5 (CE5)

80 grams of diluted phycocyanin extract was used. Only gellan gum and no carrageenan was added. The pH was adjusted to pH 4.0 using citric acid.

### Heat Treatment

The compositions obtained above for E1 and CE1 were subjected to a heat treatment with the objective of pasteurisation at a temperature between 75 °C and 80 °C for a duration between 2 and 5 minutes.

### Colour Appearance and Phase Stability of Phycocyanin Using Visual Determination.

The colour appearance and phase stability of each sample was visually determined before heat treatment, and after heat treatment, since any decrease in phase stability (phase separation and/or sedimentation) has a direct influence on the values obtained in spectrometry for the total sum of blue colour absorbance measurements.

TABLE 17
visual determination of phase stability
of compositions of E5 and CE5

| Example | E5 | CE5 |
|---|---|---|
| Before heat | Homogenous liquid, no | Homogenous liquid, no |
| treatment | sediment | sediment |
| After heat | Homogenous liquid, no | Phase separation and |
| treatment | sediment | formation of sediment |

From this visual appearance it is clear that the present invention shows a significant effect on phase stabilization of phycocyanin-containing aqueous compositions at low pH using gellan gum as another hydrocolloid. This stabilization is maintained after heat treatment (pasteurization). The comparative example shows phase separation and formation of sediment, whereas the example according to the invention shows a completely homogeneous liquid without any sedimentation or layer formation.

TABLE 18
visual determination of colour appearance
for compositions of E5 and CE5

| Example | E5 | CE5 |
|---|---|---|
| Before heat | Blue homogeneous colour | Blue homogeneous colour |
| treatment | | |
| After heat | Blue homogeneous colour | Clear liquid + blue sediment |
| treatment | | and floating particles |

From this visual appearance it is clear that the present invention shows a significant effect on colour stabilization of phycocyanin-containing aqueous compositions at low pH pH using gellan gum as another hydrocolloid. This stabilization is maintained after heat treatment (pasteurization). After heat treatment (pasteurization) the example according to the invention shows a blue colour, whereas the comparative example shows a clear liquid with blue sediments and floating particles.

Summarizing, this clearly shows that the addition of carrageenan and gellan gum according to the inventive method achieves one or more of the objects of the invention, namely increased colour stability of an aqueous phycocyanin-containing composition at low pH and increased phase stability at low pH.

1. A method of producing an aqueous phycocyanin- and hydrocolloid-containing composition, the method comprising mixing an aqueous phycocyanin-containing composition with one or more aqueous hydrocolloid-containing compositions, at a pH of 4.0 and 4.9, preferably between 4.5 and 4.9,
wherein the aqueous phycocyanin-containing composition has a phycocyanin concentration of between 0.05 and 50 wt. %, based on the weight of the aqueous phycocyanin-containing composition,
wherein the one or more aqueous hydrocolloid-containing compositions comprise multi-sulphated carrageenan and another hydrocolloid, preferably a pectin or a gum, more preferably selected from the group consisting of citrus pectin, beet pectin, arabic gum, acacia gum, cellulose gum, gellan gum, guar gum, locust bean gum, and xanthan gum, and one or more combinations thereof,
to obtain a mixture having a weight ratio of multi-sulphated carrageenan to phycocyanin of between 0.05:1 and 0.9:1 and having a weight ratio of multi-sulphated carrageenan to the other hydrocolloid of between 1:0.1 to 1:30 to obtain the aqueous phycocyanin- and hydrocolloid-containing composition.

2. Method according to claim 1, wherein the mixture obtained has a weight ratio of a multi-sulphated carrageenan to phycocyanin of:
between 0.05:1 and 0.35:1 when the mixture has a water content of less than 45 wt. % based on the weight of the mixture, or
between 0.05:1 and 0.9:1, preferably between >0.35:1 and 0.9:1, when the mixture has a water content of more than 45 wt. %.

3. Method according to claim 1, wherein multi-sulphated carrageenan and the other hydrocolloid are present in the one aqueous hydrocolloid-containing composition, preferably the one aqueous hydrocolloid-containing composition having a pH of between 3.0 and 6.0.

4. Method according to claim 1, wherein multi-sulphated carrageenan is present in the one aqueous hydrocolloid-containing composition, preferably having a pH of between 3.0 and 7.0, and the other hydrocolloid is present in another aqueous hydrocolloid-containing composition, preferably having a pH of between 2.0 and 5.0.

5. Method according to claim 1, further comprising the step of lowering the pH of the aqueous phycocyanin- and hydrocolloid-containing composition to a value of between 2.5 and 3.9, to obtain an acidic aqueous phycocyanin- and hydrocolloid-containing composition.

6. Method according to claim 4, comprising the steps mixing an aqueous phycocyanin-containing composition with one aqueous hydrocolloid-containing composition comprising multi-sulphated carrageenan, at a pH of between 4.0 and 4.9, preferably between 4.5 and 4.9, then lowering the pH of the mixture to a value of between 2.5 and 3.9, and then adding the other hydrocolloid-containing composition comprising the other hydrocolloid to obtain an acidic aqueous phycocyanin- and hydrocolloid-containing composition.

7. Method according to claim 1, further comprising one or more additional steps:
concentrating the phycocyanin- and hydrocolloid-containing composition to obtain a concentrated phycocyanin- and hydrocolloid-containing composition having a solids concentration of between 2 and 50 wt. %, preferably between 2 and 40 wt. % of solids based on the concentrated phycocyanin- and hydrocolloid-containing composition, and/or
pasteurizing the phycocyanin- and hydrocolloid-containing composition to a temperature of between 60 and 95 °C for a period of time of at least 15 seconds, to obtain a pasteurized phycocyanin- and hydrocolloid-containing composition, and/or
drying the phycocyanin- and hydrocolloid-containing composition to obtain a dried phycocyanin- and hydrocolloid-containing composition, having a water concentration of at most 15 wt. %, based on the weight of the dried composition, wherein the drying is preferably carried out by spray-drying or freeze-drying.

8. Method according to claim 1, wherein the aqueous phycocyanin-containing composition is a phycocyanin extract.

9. Method according to claim 1, comprising the steps of:
a) providing an aqueous phycocyanin-containing composition having a phycocyanin concentration of between 0.05 and 50 wt. %, based on the weight of the aqueous phycocyanin-containing composition, optionally further comprising chitosan in a weight ratio of phycocyanin to chitosan of between 1:1 and 7:1, preferably between 1.5:1 and 5:1,
b) providing an aqueous hydrocolloid-containing composition comprising multi-sulphated carrageenan and another hydrocolloid,
d) mixing the aqueous phycocyanin-containing composition of step a) with the aqueous hydrocolloid-containing composition of step b) at a pH of between 4.0 and 4.9, preferably between 4.5 and 4.9 to obtain a mixture having a weight ratio of multi-sulphated carrageenan to phycocyanin of between 0.05:1 and 0.9:1, and a weight ratio of multi-sulphated carrageenan to the other hydrocolloid of between 1:0.1 to 1:30, and
f) lowering the pH of the mixture obtained in step e) to a value of between 2.5 and 3.9, to obtain an acidic aqueous phycocyanin- and hydrocolloid-containing composition.

10. Method according to claim 1, comprising the steps of:
a) providing an aqueous phycocyanin-containing composition having a phycocyanin concentration of between 0.05 and 50 wt. %, based on the weight of the aqueous phycocyanin-containing composition, optionally further comprising chitosan in a weight ratio of phycocyanin to chitosan of between 1:1 and 7:1, preferably between 1.5:1 and 5:1,
b) providing a first aqueous hydrocolloid-containing composition comprising multi-sulphated carrageenan,
d) mixing the first aqueous phycocyanin-containing composition of step a) with the aqueous hydrocolloid-containing composition of step b) at a pH between 4.0 and 4.9, preferably between 4.5 and 4.9 to obtain a mixture having a weight ratio of multi-sulphated carrageenan to phycocyanin of between 0.05:1 and 0.9:1,
c) providing a second aqueous hydrocolloid-containing composition comprising another hydrocolloid,
e) adding the second aqueous hydrocolloid-containing composition of step c) to the mixture obtained in step d) to obtain a mixture having a weight ratio of multi-sulphated carrageenan to other hydrocolloid of between 1:0.1 to 1:30 to obtain an aqueous phycocyanin- and hydrocolloid-containing composition, and
f) lowering the pH of the mixture obtained in step e) to a value of between 2.5 and 3.9, to obtain an acidic aqueous phycocyanin- and hydrocolloid-containing composition.

11. Method according to claim 1, comprising the steps of:
a) providing an aqueous phycocyanin-containing composition having a phycocyanin concentration of between 0.05 and 50 wt. %, based on the weight of the aqueous phycocyanin-containing composition, optionally further comprising chitosan in a weight ratio of phycocyanin to chitosan of between 1:1 and 7:1, preferably between 1.5:1 and 5:1,
c) providing a second aqueous hydrocolloid-containing composition comprising another hydrocolloid,
e) adding the second aqueous hydrocolloid-containing composition of step c) to the aqueous phycocyanin-containing composition of step a) to obtain a mixture,
intermediate step) adjusting the pH of the mixture obtained in step e) to a value of between 4.0 and 4.9, preferably between 4.5 and 4.9 to obtain a pH-adjusted mixture,
b) providing a first aqueous hydrocolloid-containing composition comprising multi-sulphated carrageenan,
d) mixing the pH-adjusted mixture of the intermediate step with the aqueous hydrocolloid-containing composition of step b) at a pH of between 4.0 and 4.9, preferably between 4.5 and 4.9 to obtain a mixture having a weight ratio of multi-sulphated carrageenan to phycocyanin of between 0.05:1 and 0.9:1, and a weight ratio of multi-sulphated carrageenan to the other hydrocolloid of between 1:0.1 to 1:30,
f) lowering the pH of the mixture obtained in step e) to a value of between 2.5 and 3.9, to obtain an acidic aqueous phycocyanin- and hydrocolloid-containing composition.

12. Method according to claim 1, comprising the steps of:
a) providing an aqueous phycocyanin-containing composition having a phycocyanin concentration of between 0.05 and 50 wt. %, based on the weight of the aqueous phycocyanin-containing composition, optionally further comprising chitosan in a weight ratio of phycocyanin to chitosan of between 1:1 and 7:1, preferably between 1.5:1 and 5:1,
b) providing a first aqueous hydrocolloid-containing composition comprising multi-sulphated carrageenan,
d) mixing the first aqueous phycocyanin-containing composition of step a) with the aqueous hydrocolloid-containing composition of step b) at a pH between 4.0 and 4.9, preferably between 4.5 and 4.9 to obtain a mixture having a weight ratio of multi-sulphated carrageenan to phycocyanin of between 0.05:1 and 0.9:1,
f) lowering the pH of the mixture obtained in step d) to a value of between 2.5 and 3.9, to obtain an acidic mixture,
c) providing a second aqueous hydrocolloid-containing composition comprising another hydrocolloid,
e) adding the second aqueous hydrocolloid-containing composition of step c) to the acidic mixture obtained in step f) to obtain an aqueous phycocyanin- and hydrocolloid-containing composition having a weight ratio of multi-sulphated carrageenan to hydrocolloid of between 1:0.1 to 1:30 to obtain.

13. An aqueous phycocyanin- and carrageenan-containing composition, comprising:
between 40 and 99 wt. % of water, preferably between 65 and 98 wt. %,
between 0.05 and 55 wt. % of phycocyanin,
multi-sulphated carrageenan in a weight ratio of multi-sulphated carrageenan to phycocyanin of between 0.05:1 and 0.9:1,
another hydrocolloid in a weight ratio of multi-sulphated carrageenan to the other hydrocolloid of between 1:0.1 to 1:30,
optionally chitosan in a weight ratio of phycocyanin to chitosan of between 1:1 and 7:1, preferably between 1.5:1 and 5:1,
said composition having a pH of between 2.5 and 3.9, preferably between 2.8 and 3.6.

14. A dried phycocyanin- and carrageenan-containing composition, comprising:
between 1 and 15 wt. % of water.
between 2 and 90 wt. % of phycocyanin,
multi-sulphated carrageenan in a weight ratio of multi-sulphated carrageenan to phycocyanin of between 0.05:1 and 0.9:1,
another hydrocolloid in a weight ratio of multi-sulphated carrageenan to the other hydrocolloid of between 1:0.1 to 1:30,
optionally chitosan in a weight ratio of phycocyanin to chitosan of between 1:1 and 7:1, preferably between 1.5:1 and 5:1, and
said composition having a pH of between 2.5 and 3.9, preferably between 2.8 and 3.6.

15. A method of preparing a food composition by mixing the phycocyanin- and hydrocolloid-containing composition according to claim 13 with one or more diluents selected from the group consisting of water, milk, plant-based milk, and juices and/or one or more further ingredients selected from the group consisting of flavouring agents, fibers, inulins, chelating agents, spices, emulsifiers, hydrocolloids, herb extracts, vitamins, and minerals, to a concentration of phycocyanin of between 0.001 and 20 wt. %, optionally diluting with water, optionally adjusting the pH, to achieve a composition having a pH of between 2.5 and 3.9.

16. A food composition comprising the phycocyanin- and hydrocolloid-containing composition according to claim 13, having a concentration of phycocyanin of between 0.001 and 20 wt. %, having a pH of between 2.5 and 7, and optionally further comprising milk, plant-based milk, juices, flavours, chelating agents, spices, emulsifiers, hydrocolloids, herb extracts, vitamins, and minerals.
